(19) United States
(12) Patent Application Publication
(10) Pub. No.: US 2012/0127074 A1
(43) Pub. Date: May 24, 2012

(54) SCREEN OPERATION SYSTEM

(75) Inventors: Fumio NAKAMURA, Fukuoka (JP); Satoru MIYANISHI, Osaka (JP)

(73) Assignee: PANASONIC CORPORATION, Osaka (JP)

(21) Appl. No.: 13/296,763

(22) Filed: Nov. 15, 2011

(30) Foreign Application Priority Data
Nov. 18, 2010 (JP) 2010-257779

(51) Int. Cl. G06F 3/033

(52) U.S. Cl. 345/158

(57) ABSTRACT

A screen operation system obtains operation information associated with an operation performed by a user with a pointing object relative to a screen of an image display apparatus controlled by an information processing apparatus and causes the information processing apparatus to execute processing associated with the operation information. The screen operation system includes a mobile information apparatus including a camera capturing an image of the screen of the image display apparatus; a display displaying the image captured by the camera; and a communicator communicating information with the information processing apparatus. The camera of the mobile information apparatus captures an image such that the pointing object is displayed overlapping a predetermined position on the screen of the image display apparatus. Based on captured image information obtained thereby, operation information is obtained.

### CROSS-REFERENCE TO RELATED APPLICATIONS

The present application claims priority under 35 U.S.C. §119 of Japanese Application No. 2010-257779 filed on Nov. 18, 2010, the disclosure of which is expressly incorporated by reference herein in its entirety.

### BACKGROUND OF THE INVENTION

1. Field of the Invention

The present invention relates to a screen operation system allowing a user to operate a screen displayed on an image display apparatus by an information processing apparatus.

2. Description of Related Art

A screen operation system operated through what is commonly referred to as a Graphical User Interface (GUI) is widely used, in which a screen is displayed on an image display apparatus by predetermined programs in an information processing apparatus; and a user uses an input device, such as a mouse, to operate an operation target, such as an icon, on the screen, to provide predetermined instructions to programs executed in the information processing apparatus.

Using a projector as an image display apparatus provides a large screen, which is suitable for a conference with a large audience. In order to operate the screen, however, an input device is required which is connected to an information processing apparatus that controls the projector. In the case where a plurality of users operate the screen, it is inconvenient for the users to take turns to operate the input device of the information processing apparatus.

A known technology related to such a screen operation system using a projector screen allows a user to move a pointing object, such as a fingertip, in front of the projected screen for screen operation (refer to Related Art 1).

The conventional technology mentioned above captures a projected screen using a camera installed in the projector, analyzes a captured image of a pointing object, such as a user's hand, that overlaps the screen, and detects operation of the pointing object. It is necessary to move the pointing object so as to overlap an operation target, such as an icon, on the screen. There is thus a problem in which a person who operates the screen must be in front of the screen for screen operation and thus cannot readily operate the screen.
[Related Art 1] Japanese Patent Laid-open Publication No. 2009-64109

### SUMMARY OF THE INVENTION

In view of the circumstances above, an object of the present invention is to provide a screen operation system configured to allow easy screen operation.

An advantage of the present invention provides a screen operation system obtaining operation information associated with an operation performed by a user with a pointing object relative to a screen of an image display apparatus controlled by an information processing apparatus and causing the information processing apparatus to execute processing associated with the operation information. The screen operation system includes a mobile information apparatus including a camera capturing an image of the screen of the image display apparatus; a display displaying the image captured by the camera; and a communicator communicating information with the information processing apparatus. The operation information is obtained based on captured image information obtained from the image captured by the camera such that the pointing object is displayed at a predetermined position on the screen of the image display apparatus.

According to the present invention, a user uses the mobile information apparatus that he carries to capture the screen of the image display apparatus and to operate the screen. Thus, the user can operate the screen if he is in a place where he can see the screen of the image display apparatus. Accordingly, the user can operate the screen without being in front of the screen.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates an overall configuration of a screen operation system according to a first embodiment of the present invention;

FIG. 2 schematically illustrates configurations of a mobile information apparatus and an information processing apparatus;

FIG. 3 is a flowchart of a processing procedure in the mobile information apparatus of FIG. 2;

FIG. 4 illustrates an overall configuration of a screen operation system according to a second embodiment of the present invention;

FIG. 5 schematically illustrates configurations of a mobile information apparatus and an information processing apparatus;

FIG. 6 is a flowchart of a processing procedure in the mobile information apparatus of FIG. 5;

FIGS. 7A to 7C each illustrate image correction processing to correct distortion of the image;

FIG. 8 schematically illustrates configurations of the mobile information apparatus and the information processing apparatus of FIG. 2;

FIG. 9 is a perspective view illustrating another example of an image display apparatus according to the present invention; and

FIG. 10 illustrates an overall configuration of a modified screen operation system of the present invention.

### DETAILED DESCRIPTION OF PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

The embodiments of the present invention are explained below with reference to the drawings.

### First Embodiment

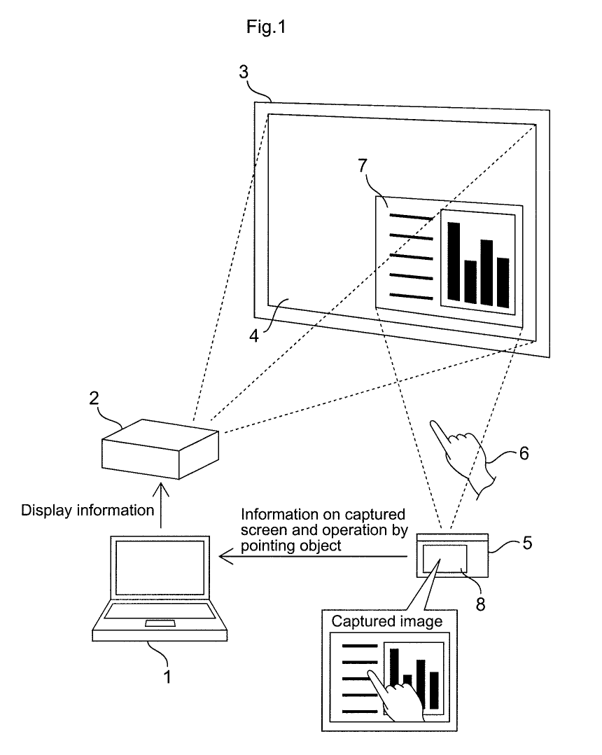

FIG. 1 illustrates an overall configuration of a screen operation system according to the first embodiment of the present invention. In the screen operation system, a projector (image display apparatus) 2 controlled by an information processing apparatus 1 obtains operation information of a user's operation relative to a projected screen 4 displayed on a screen 3 and causes the information processing apparatus 1 to execute processing associated with the operation information. To operate the projected screen 4 of the projector 2, a user uses a mobile information apparatus 5 that the user carries.

Examples of the mobile information apparatus 5 include mobile telephone terminals (including Personal Handy-phone System (PHS) terminals), smartphones, and PDAs. The mobile information apparatus 5 has a camera that captures the projected screen 4 of the projector 2. A user captures an image of the projected screen 4 of the projector 2 using the mobile information apparatus 5. While viewing a screen of a display 8 on which the captured image is displayed, the user moves a pointing object 6, such as the user's hand or fingertip or a pointer, onto a predetermined position where an operation target, such as an icon, is located on the projected screen 4 of the projector 2. Thereby, the user operates the projected screen 4 of the projector 2.

The mobile information apparatus 5 captures a capture area 7 along with the pointing object 6, such as a finger, the capture area 7 being provided in a field angle of the camera within the projected screen 4 of the projector 2. The captured image includes the pointing object 6, such as a finger, that overlaps a predetermined position in the capture area 7. Based on the captured image information, operation information is obtained pertaining to the operation performed by the user with the pointing object 6 relative to the projected screen 4 of the projector 2.

The mobile information apparatus 5 and the information processing apparatus 1 can communicate with each other through a wireless communication medium, such as a wireless LAN. The mobile information apparatus 5 and the information processing apparatus 1 share a processing load of obtaining the operation information from the captured image information, and the mobile information apparatus 5 transmits predetermined information to the information processing apparatus 1 on a real-time basis.

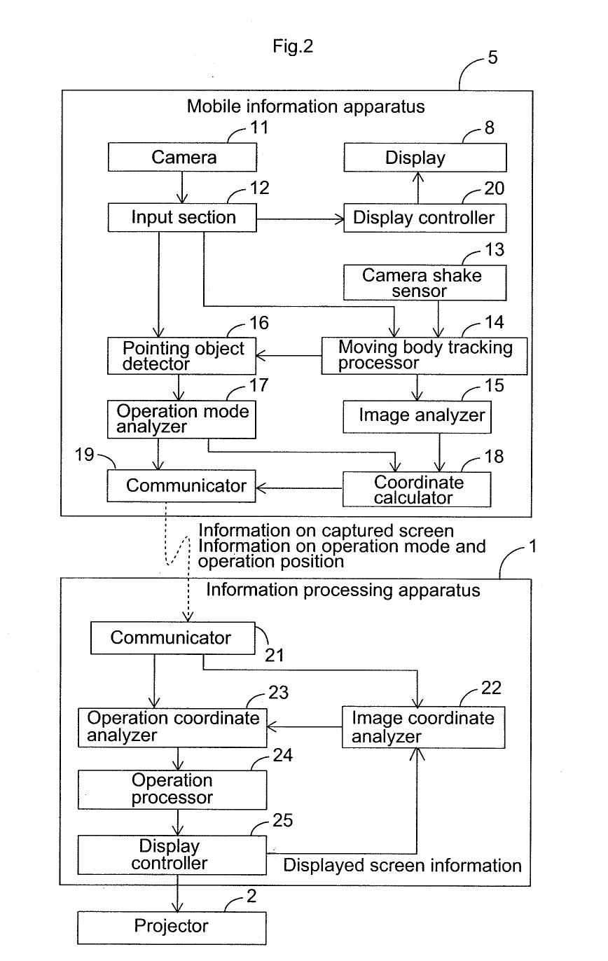

FIG. 2 schematically illustrates configurations of the mobile information apparatus 5 and the information processing apparatus 1 shown in FIG. 1. The mobile information apparatus 5 includes a camera 11, an input section 12, a camera shake sensor 13, a moving body tracking processor 14, an image analyzer 15, a pointing object detector 16, an operation mode analyzer 17, a coordinate calculator 18, and a communicator 19.

Based on the captured image information output from the input section 12 and camera shake information output from the camera shake sensor 13, the moving body tracking processor 14 detects a relative movement of a captured object and the camera 11.

Based on the information obtained in the moving body tracking processor 14, the image analyzer 15 identifies the screen 3 and then an area of the projected screen 4 on the screen 3. The projection area is identified based on an indicator image displayed in a predetermined position on the projected screen 4. The indicator image is a distinctive image within the projected screen 4, such as, for example, an image of a start button displayed at the lower left of the projected screen 4. It is possible to use an image of a marker displayed on the projected screen particularly for identifying the projection area.

Based on the captured image information output from the input section 12 and the information obtained in the moving body tracking processor 14, the pointing object detector 16 detects, by movement recognition, a portion where a movement is different from the entire captured image, and then determines, by shape recognition, whether the portion is a pointing object. The pointing object is recognized herein from characteristics of its shape (e.g., shape of a pen, a pointer, a hand, a finger, or a nail).

Based on the information obtained in the pointing object detector 16, the operation mode analyzer (operation mode determinator) 17 determines an operation mode associated with the movement of the pointing object 6. Examples of the operation mode include tapping (patting with a finger), flicking (lightly sweeping with a finger), pinch-in/pinch-out moving two fingers toward or apart each other), and other gestures. For example, a user can tap to select (equivalent to clicking or double-clicking of a mouse), flick to scroll the screen or turn pages, and pinch-in/pinch-out to zoom-out/zoom-in on the screen.

Based on the information obtained in the image analyzer 15 and the operation mode analyzer 17, the coordinate calculator (first operation position obtainer) 18 obtains a relative position of the pointing object 6 on the capture area 7. A coordinate of a pointed position indicated by the pointing object 6 (position of a fingertip in the case where a hand is identified as the pointing object 6) is calculated herein.

The display 8 is controlled by a display controller 20, to which the captured image information captured by the camera 11 is input through the input section 12. The captured image is then displayed on the display 8.

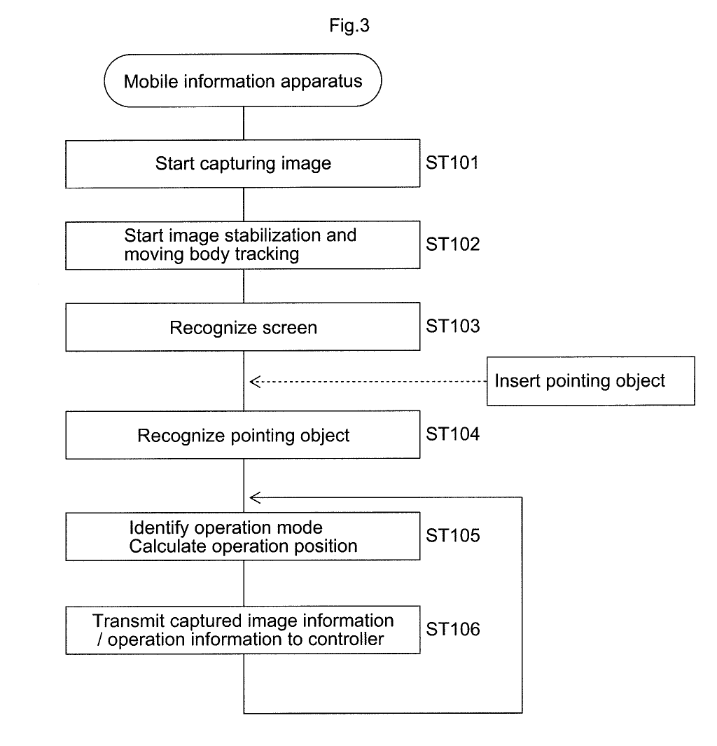

FIG. 3 is a flowchart of a processing procedure in the mobile information apparatus 5. The camera 11 of the mobile information apparatus 5 is first activated to start capturing the projected screen 4 projected on the screen 3 by the projector 2 (ST101). The moving body tracking processor 14 then starts image stabilization and moving body tracking (ST102). The image analyzer 15 identifies the screen 3 and an area of the projected screen 4 on the screen 3 (ST103).

With the pointing object 6, such as a finger, appearing in the area captured by the camera 11, the pointing object detector 16 identifies the pointing object (ST104). Then, the operation mode analyzer 17 determines an operation mode, such as tapping or flicking, and the coordinate calculator 18 obtains an operation position, specifically a relative position of the pointing object 6 on the capture area 7 (ST105). The communicator 19 transmits, to the information processing apparatus 1, information pertaining to the captured projected screen, the operation mode, and the operation position obtained in the steps above (ST106).

As shown in FIG. 2, the information processing apparatus 1 includes a communicator 21, an image coordinate analyzer 22, an operation coordinate analyzer 23, an operation processor 24, and a display controller 25.

The display controller 25 controls display operation of the projector 2 and outputs screen information being displayed by the projector 2 to the image coordinate analyzer 22.

Based on the captured image information received in the communicator 21 and the displayed screen information output from the display controller 25, the image coordinate analyzer (captured position obtainer) 22 obtains an absolute position of the capture area 7 relative to the entire projected screen 4 of the projector 2. In this process, the capture area 7 relative to the entire projected screen 4 is obtained through matching and detailed coordinates are calculated for the identified capture area 7.

Based on the information of the pointing object 6 received in the communicator 21, specifically the information of the relative position of the pointing object 6 on the capture area 7, the operation coordinate analyzer (second operation position obtainer) 23 obtains an absolute position of the pointing object 6 relative to the entire projected screen 4 of the projector 2. Based on the information of the position of the pointing object 6, an operation target (selection menu or icon) on the projected screen 4 is identified. In addition, based on the information of the operation mode, such as tapping or flicking, received in the communicator 21, information on operation details (operation information) is output, the information on operation details indicating what kind of operation was performed on the projected screen 4 by the pointing object.

Based on the information on operation details (operation information) obtained in the operation coordinate analyzer 23, the operation processor 24 executes processing associated with the operation details.

A variety of necessary processes are divided and assigned to the mobile information apparatus 5 and the information processing apparatus 1. It is also possible to perform the processes in either the mobile information apparatus 5 or the information processing apparatus 1. For example, the operation mode analyzer 17 of the mobile information apparatus 5 determines the operation mode, such as tapping or flicking. Instead, the information processing apparatus 1 may determine the operation mode.

In order to reduce a communication load on the mobile information apparatus 5 and to reduce a calculation load on the information processing apparatus 1 in the case where a plurality of users perform screen operations using the mobile information apparatuses 5, it is desirable that the mobile information apparatus 5 be configured to perform as many necessary processes as possible within the processing capacity of the mobile information apparatus 5.

### Second Embodiment

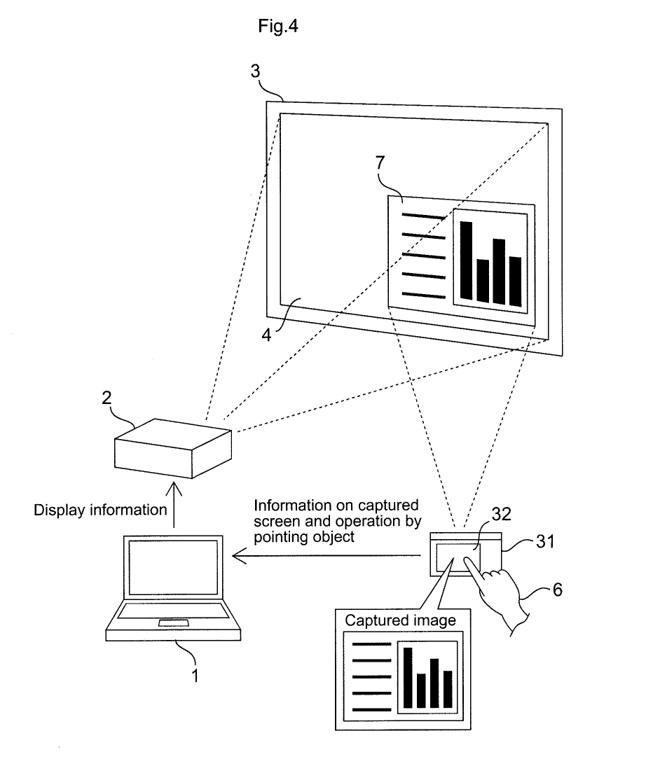

FIG. 4 illustrates an overall configuration of a screen operation system according to the second embodiment of the present invention. Similar to the first embodiment, the screen operation system includes an information processing apparatus 1, a projector (image display apparatus) 2, and a mobile information apparatus 31. A user uses the mobile information apparatus 31 that the user carries to operate a projected screen 4 displayed on a screen 3 by the projector 2. In addition to camera and wireless communication functions, the mobile information apparatus 31 has a touch screen display 32, in particular herein.

The touch screen display 32 of the mobile information apparatus 31 displays an image captured by the camera and detects a touch operation by a pointing object 6, such as a fingertip, on the screen. While capturing the projected screen 4 of the projector 2 with the camera, the user moves the pointing object 6 on the touch screen display 32 on which the captured image is displayed and thereby operates the projected screen 4 of the projector 2.

The mobile information apparatus 31 captures a capture area 7 provided in a field angle of the camera within the projected screen 4 of the projector 2. Based on captured image information obtained therefrom and operation position information obtained from the touch operation of the pointing object 6 on the touch screen display 32 on which the captured area 7 is displayed, operation information is obtained pertaining to the user's operation performed with the pointing object 6 relative to the projected screen 4 of the projector 2.

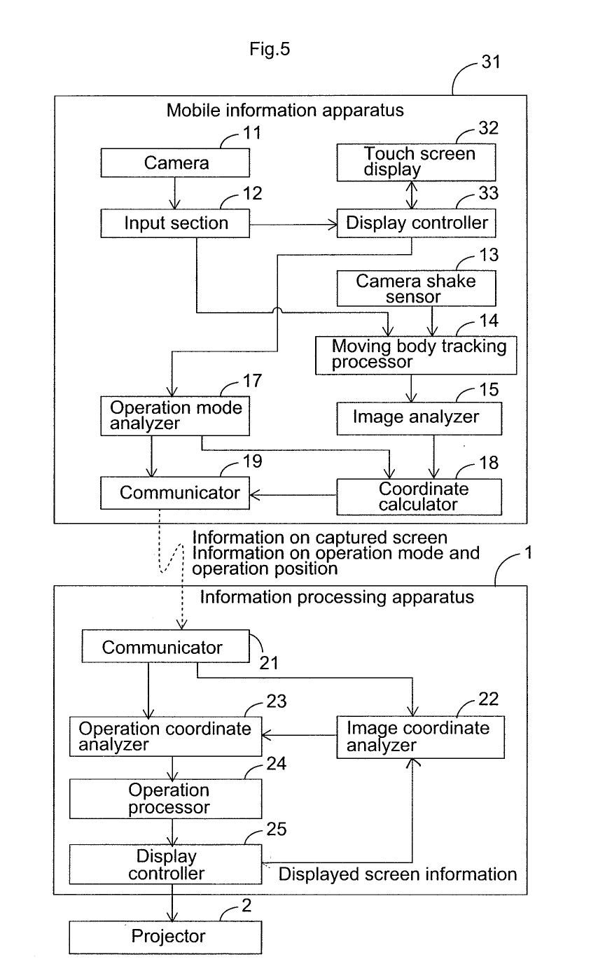

FIG. 5 schematically illustrates configurations of the mobile information apparatus 31 and the information processing apparatus 1 shown in FIG. 4. The same reference numerals are assigned to the same configurations as those in the first embodiment shown in FIG. 2, and detailed explanations thereof are omitted.

In the mobile information apparatus 31, the touch screen display 32 is controlled by a display controller 33, to which the captured image information captured by the camera 11 is input through an input section 12. The captured image is then displayed on the touch screen display 32. Furthermore, the display controller 33 detects a touch operation performed by the pointing object 6, such as a fingertip, on the touch screen display 32 and outputs information of a touch position.

The touch position information is input to an operation mode analyzer 17, which determines an operation mode, such as tapping or flicking, associated with the movement of the pointing object 6 based on the touch position information. Furthermore, the touch position information is input to the coordinate calculator 18 through the operation mode analyzer 17. The coordinate calculator 18 obtains a relative position of the pointing object 6 on the capture area 7 based on the touch position information.

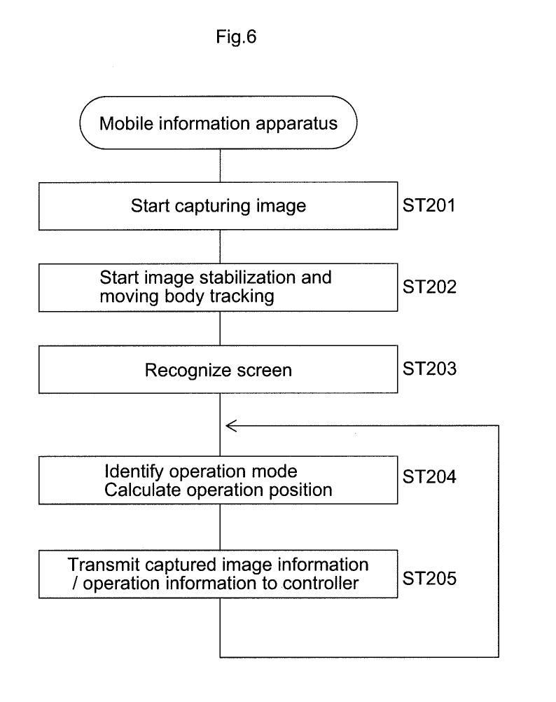

FIG. 6 is a flowchart of a processing procedure in the mobile information apparatus 31. Similar to the first embodiment shown in FIG. 3, the projected screen 4 on the screen 3 by the projector 2 starts to be captured (ST201), and then image stabilization and moving body tracking start (ST202). The screen 3 and an area of the projected screen 4 on the screen 3 are identified (ST203). Subsequently, based on the touch position information output from the display controller 33, the operation mode, such as tapping or flicking, is determined and the operation position is calculated (ST204). The information obtained in the processes above is transmitted to the information processing apparatus 1, the information pertaining to the captured projected screen, the operation mode, and the operation position (ST205).

The information processing apparatus 1 is the same as that in the first embodiment and performs the same processing.

As described above, in the screen operation systems according to the first and second embodiments of the present invention, a user uses the mobile information apparatuses 5 and 31, respectively, that he carries to capture the projected screen 4 of the projector 2 and to operate the screen. Thus, the user can operate the screen if he is in a place where he can see the projected screen 4 of the projector 2. Accordingly, the user can operate the screen while he sits at his own chair without going in front of the screen 3.

In addition, screen operation is not limited regardless of conditions. For example, even in the case where the pointing object cannot reach an operation target, such as an icon, on the screen because of the very large size of the screen 3, the systems allow the user to operate the screen, thus providing a high level of convenience. In the case where a plurality of users operate the screen, they use the mobile information apparatuses 5 and 31 that they carry for screen operation, eliminating the inconvenience of taking turns to operate an input device of the information processing device 1 and allowing simple screen operation. Furthermore, the mobile information apparatuses 5 and 31 may be widely used mobile telephone terminals each equipped with a camera. It is thus unnecessary to prepare exclusive devices for a number of users to operate the screen, reducing the installation cost.

In particular, a relative position of the pointing object 6 on the capture area 7 in the projected screen 4 of the projector 2 is obtained and the position of the capture area 7 relative to the entire projected screen 4 of the projector 2 is obtained. Then, an absolute position of the pointing object 6 is obtained relative to the entire projected screen 4 of the projector 2. Thus, only a portion of the projected screen 4 of the projector 2 needs to be captured by the mobile information apparatuses 5 and 31 for screen operation, thus facilitating screen operation.

The operation mode is determined which is associated with the movement of the pointing object 6, such as tapping, flicking, or pinch-in/pinch-out. Assigning processing to each operation mode, the processing including selection, scroll of the screen, page turning, and zoom-in or zoom-out of the screen, allows a variety of instructions with the movement of the pointing object 6, thus facilitating screen operation.

A projector is used as the image display apparatus in the first and second embodiments. The image display apparatus of the present invention, however, is not limited to a projector, and may be an image display apparatus that uses a plasma display panel or an LCD panel.

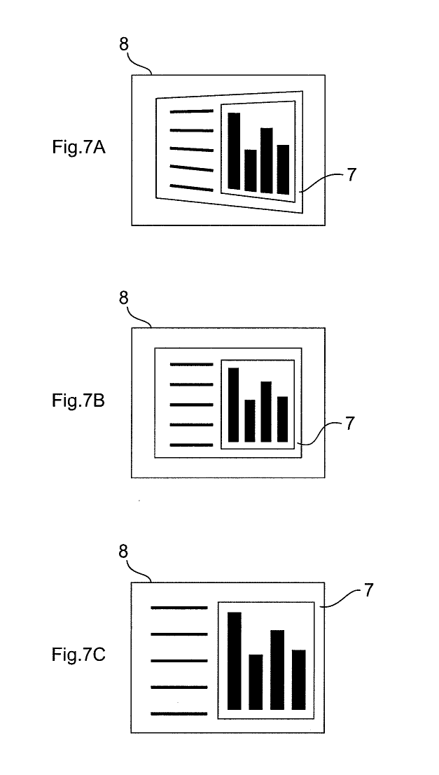

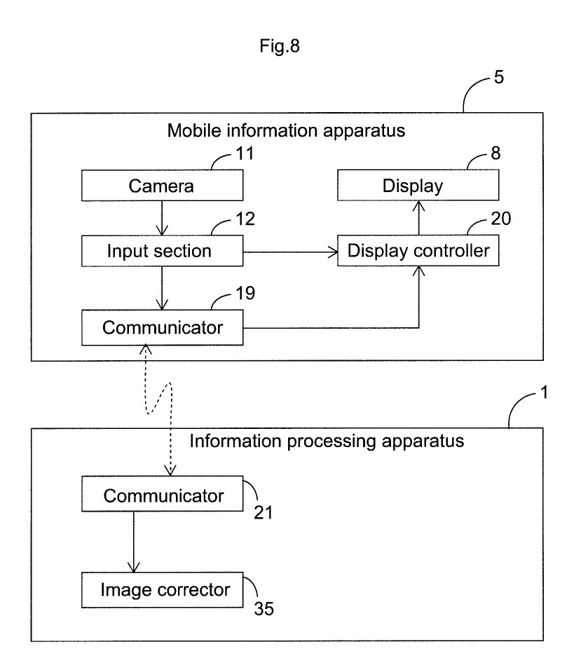

FIGS. 7A to 7C each illustrate an image of the capture area 7 displayed on the display 8 of the mobile information apparatus 5. FIG. 7A illustrates a state before distortion of an image is corrected; FIG. 7B illustrates a state after the image is corrected; and FIG. 7C illustrates a state in which the image is enlarged. FIG. 8 schematically illustrates configurations of the mobile information apparatus 5 and the information processing apparatus 1.

FIG. 8 illustrates an example of an image correction process applied in the first embodiment. Only a main portion of the image correction process is illustrated. The descriptions in the first embodiment apply unless otherwise mentioned in particular. The image correction process described herein can be applied to both the first and second embodiments.

In the case where a user captures the projected screen 4 on the screen 3 from an angle using the camera 11 of the mobile information apparatus 5, the capture area 7 having a rectangular shape on the screen 3 is displayed in a distorted quadrangular shape, as shown in FIG. 7A, making operation difficult with the pointing object 6, such as a finger. The captured image is then corrected and displayed as viewed from the front of the screen 3, as shown in FIGS. 7B and 7C. Correcting distortion of the captured image as above improves visibility of the captured image, thus facilitating screen operation.

As shown in FIG. 8, the information processing apparatus 1 is provided with an image corrector 35 that corrects distortion of a captured image caused by capturing the screen of the projector (image display apparatus) 2 from an angle. The captured image information output from the camera 11 of the mobile information apparatus 5 is transmitted to the information processing apparatus 1. The distorted captured image is corrected in the image corrector 35, and the corrected captured image information is transmitted to the mobile information apparatus 5.

If the corrected captured image is displayed as-is on the mobile information apparatus 5, the corrected captured image is displayed small in the screen of the display 8, as shown in FIG. 7B. Thus, the zoom-in function of the mobile information apparatus 5 is used to enlarge the corrected captured image, as shown in FIG. 7C.

Since the calculation load of the image correction is large, the image correction is performed in the information processing apparatus 1. The image correction, however, may be performed in a mobile information apparatus 5 having high processing performance.

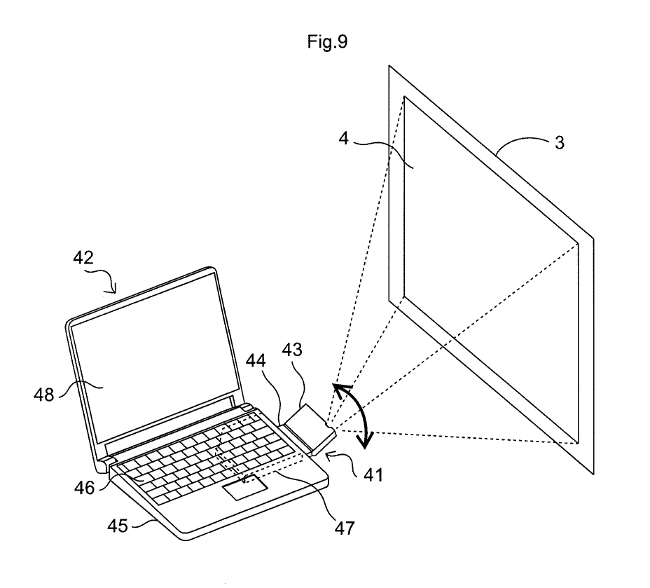

FIG. 9 is a perspective view illustrating another example of an image display apparatus according to the present invention. An image display apparatus 41 is installed in a portable information processing apparatus 42. The image display apparatus 41 includes an optical engine unit 43 and a control unit 44, the optical engine unit 43 housing optical components to project the projected screen 4 on the screen 3, the control unit 44 housing a board that controls the optical components in the optical engine unit 43. The optical engine unit 43 is rotatably supported by the control unit 44. The image display unit 41 employs a semiconductor laser as a light source.

A drive bay or a housing space in which a peripheral, such as an optical disk apparatus, is replaceably housed is provided on a rear side of a keyboard 46 of a case 45 of the portable information processing apparatus 42. A case 47 of the image display apparatus 41 is attached to the drive bay such that the optical engine unit 43 and the control unit 44 are retractably provided in the case 47. For use, in a state where the optical engine unit 43 and the control unit 44 are pulled out, the optical engine unit 43 is rotated to adjust a projection angle of laser light from the optical engine unit 43 for appropriate display of the projected screen 4 on the screen 3.

The image display apparatus 41, which is installed in the portable information processing apparatus 42, can be readily used in a conference with a relatively small number of people. Furthermore, the projected screen 4 can be displayed substantially larger than a display 48 of the portable information processing apparatus 42, thus allowing a user to view the projected screen 4 while being seated in his own seat. In the case where the image display apparatus 41 is used in combination with the above-described screen operation system of the present invention, users do not have to take turns to operate the portable information processing apparatus 42. They can instead use the mobile information apparatuses 5 and 31 that they carry at their seats to operate the screen of the image display apparatus 41, thus providing a high level of convenience.

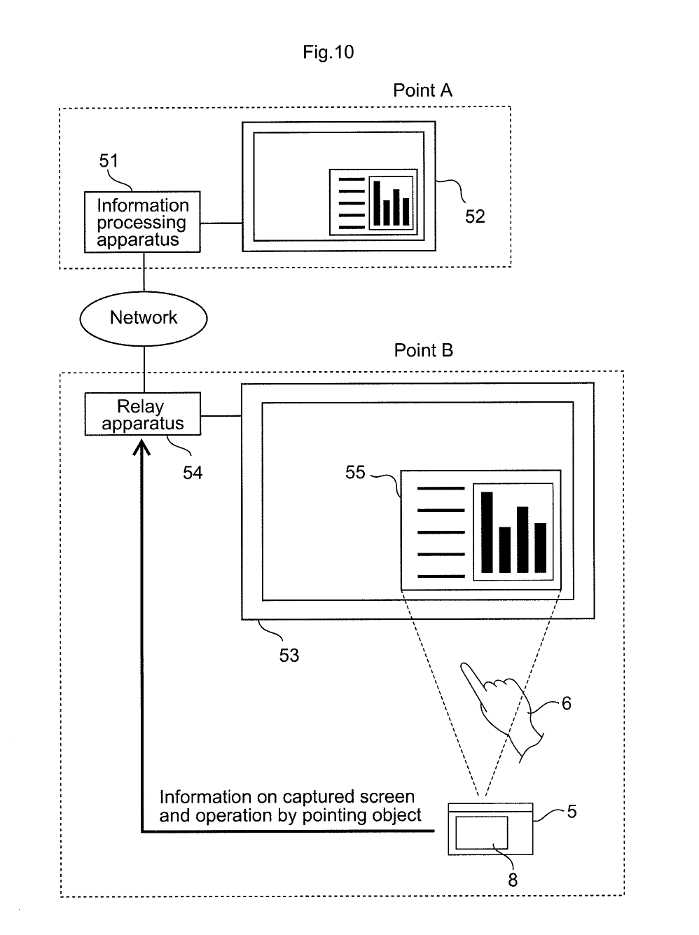

FIG. 10 illustrates an overall configuration of a modified screen operation system of the present invention. In a remote display system that displays a screen of an image display apparatus 52 controlled by an information processing apparatus 51 identically on an image display apparatus 53 in a remote place or in a different room, the image display system allows a user viewing the screen of the image display apparatus 53 to operate the output screen of the information processing apparatus 51 using the mobile information apparatus 5.

In the screen operation system, the information processing apparatus 51 at Point A is connected with a relay apparatus 54 at Point B via a network. In this regard, any conventional wired or wireless network can be utilized. Display signals are transmitted from the information processing apparatus 51 to the relay apparatus 54, which controls the image display apparatus 53 to display the screen. The mobile information apparatus 5 is the mobile information apparatus shown in the first embodiment and thus the screen can be operated in the same manner as in the first embodiment.

The information processing apparatus 51 may have the same configuration as the information processing apparatus 1 shown in the first embodiment. Communication with the mobile information apparatus 5 is performed via the network and the relay apparatus 54. The relay apparatus 54 and the mobile information apparatus 5 can communicate with each other via a wireless communication medium, such as a wireless LAN.

The mobile information apparatus 5 shown in the first embodiment is used in this example. However, the mobile information apparatus 31 shown in the second embodiment may also be applied to the screen operation system.

The screen operation system of the present invention allows easy screen operation. It is useful as a screen operation system in which a user operates a screen displayed on an image display apparatus by an information processing apparatus.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A screen operation system obtaining operation information associated with an operation performed by a user with a pointing object relative to a screen of an image display apparatus controlled by an information processing apparatus and causing the information processing apparatus to execute processing associated with the operation information, the screen operation system comprising:
a mobile information apparatus comprising:
a camera capturing an image of the screen of the image display apparatus;
a display displaying the image captured by the camera; and
a communicator communicating information with the information processing apparatus, wherein
the operation information is obtained based on captured image information obtained from the image captured by the camera such that the pointing object is displayed at a predetermined position on the screen of the image display apparatus.

2. The screen operation system according to claim 1, wherein at least one of the mobile information apparatus and the information processing apparatus comprises:
a first operation position obtainer obtaining a relative position of the pointing object to a capture area captured by the camera within the screen of the image display apparatus.

3. The screen operation system according to claim 2, wherein at least one of the mobile information apparatus and the information processing apparatus comprises:
a capture position obtainer obtaining an absolute position of the capture area in the entire screen of the image display apparatus.

4. The screen operation system according to claim 3, wherein at least one of the mobile information apparatus and the information processing apparatus comprises:
a second operation position obtainer obtaining an absolute position of the pointing object in the entire screen of the image display device based on the information obtained by the first operation position obtainer and the capture position obtainer.

5. The screen operation system according to claim 1, wherein at least one of the mobile information apparatus and the information processing apparatus comprises:
an operation mode determinator determining an operation mode associated with a movement of the pointing object.

6. The screen operation system according to claim 1, wherein at least one of the mobile information apparatus and the information processing apparatus comprises:
an image corrector correcting distortion of the captured image caused by oblique capture of the screen of the image display apparatus by the camera.

7. A screen operation system obtaining operation information associated with an operation performed by a user with a pointing object relative to a screen of an image display apparatus controlled by an information processing apparatus and causing the information processing apparatus to execute processing associated with the operation information, the screen operation system comprising:
a mobile information apparatus comprising:
a camera capturing an image of the screen of the image display apparatus;
a touch screen display displaying the image captured by the camera and detecting a touch operation by the pointing object on the screen; and
a communicator communicating information with the information processing apparatus, wherein
the operation information is obtained based on captured image information obtained from the image of the screen of the image display apparatus captured by the camera and operation position information obtained from the touch operation performed on the touch screen display on which the captured image is displayed.

8. The screen operation system according to claim 7, wherein at least one of the mobile information apparatus and the information processing apparatus comprises:
a first operation position obtainer obtaining a relative position of the pointing object to a capture area captured by the camera within the screen of the image display apparatus.

9. The screen operation system according to claim 8, wherein at least one of the mobile information apparatus and the information processing apparatus comprises:
a capture position obtainer obtaining an absolute position of the capture area in the entire screen of the image display apparatus.

10. The screen operation system according to claim 9, wherein at least one of the mobile information apparatus and the information processing apparatus comprises:
a second operation position obtainer obtaining an absolute position of the pointing object in the entire screen of the image display device based on the information obtained by the first operation position obtainer and the capture position obtainer.

11. The screen operation system according to claim 7, wherein at least one of the mobile information apparatus and the information processing apparatus comprises:
an operation mode determinator determining an operation mode associated with a movement of the pointing object.

12. The screen operation system according to claim 7, wherein at least one of the mobile information apparatus and the information processing apparatus comprises:
an image corrector correcting distortion of the captured image caused by oblique capture of the screen of the image display apparatus by the camera.

13. The screen operation system according to claim 1, wherein the information processing apparatus and the mobile information apparatus are connected to a network to receive/transmit information via the network, the communicator comprising a relay apparatus operatively coupled to the network and to the mobile information apparatus.

14. The screen operation system according to claim 7, wherein the information processing apparatus and the mobile information apparatus are connected to a network to receive/transmit information via the network, the communicator comprising a relay apparatus operatively coupled to the network and to the mobile information apparatus.

15. The screen operation system according to claim 1, wherein the system is configured such that when a pointing object is moved to a predetermined position where an operation target is located on an image displayed on the display of the camera, the operation target can be operated.

16. The screen operation system according to claim 1, wherein the camera of the mobile information apparatus is configured to capture an area together with the pointing object, the area comprising at least a portion of the image displayed on the screen of the image display apparatus and being within a field angle of the camera.

17. The screen operation system according to claim 1, wherein the mobile information apparatus is further comprising a moving body tracker that detects relative movement between the captured image and the camera, and a pointing object detector that determines, whether movement of a portion of the captured image is different than movement of the entire captured image and determines, based on shape recognition, whether the portion of the captured image is the pointing object.

18. The screen operation system according to claim 5, wherein the operation mode includes at least tapping, flicking and pinch in/pinch out.

19. The screen operation system according to claim 1, wherein the pointing object comprises at least one of a pen, a pointer, a hand, a finger, and a nail.

20. The screen operation system according to claim 1, wherein a plurality of mobile information apparatuses are usable together with an image display apparatus controlled by a single information processing apparatus to cause the information processing apparatus to execute processing associated with the operation information.

21. The screen operation system according to claim 15, wherein the operation target comprises at least one of a selection menu and an icon.
